(19) United States
(12) Patent Application Publication
(10) Pub. No.: US 2014/0257750 A1
(43) Pub. Date: Sep. 11, 2014

(54) SYSTEM AND METHOD FOR ESTIMATING UNCERTAINTY FOR GEOPHYSICAL GRIDDING ROUTINES LACKING INHERENT UNCERTAINTY ESTIMATION

(71) Applicants: Paul A. Elmore, Slidell, LA (US); Samantha J. Zambo, Picayune, MS (US)

(72) Inventors: Paul A. Elmore, Slidell, LA (US); Samantha J. Zambo, Picayune, MS (US)

(73) Assignee: The Government of the United States of America, as represented by the Secretary of the Navy, Washington, DC (US)

(21) Appl. No.: 14/200,153

(22) Filed: Mar. 7, 2014

Related U.S. Application Data
(60) Provisional application No. 61/774,617, filed on Mar. 8, 2013.

(51) Int. Cl. G06F 17/18; G06F 17/50

(52) U.S. Cl. CPC G06F 17/18; G06F 17/50
USPC 702/181

(57) ABSTRACT

System and method for improving the accuracy of a numerical model by estimating uncertainty for gridding algorithms. An extra uncertainty term is added to the zeroth-order CUBE uncertainty estimator to compute uncertainty which can be provided to a numerical model. The system and method can estimate the uncertainty for any spatial data, for example, but not limited to, bathymetry data.

### CROSS-REFERENCE TO RELATED APPLICATIONS

This application claims the benefit of priority based on U.S. Provisional Patent Application No. 61/774,617 filed on Mar. 8, 2013, the entirety of which is hereby incorporated by reference into the present application.

### BACKGROUND

Methods and systems disclosed herein relate generally to numerical model gridding, and in particular, to estimating the uncertainty of interpolation used to create the grids.

Geophysical data often are sparse and irregularly spaced. Gridding algorithms are frequently applied to interpolate the data to a grid. An example is Splines-In-Tension (Smith, W. H. F., and P. Wessel (1990), Gridding with continuous curvature splines in tension, Geophysics, 55(3), 293-305, doi: 10.1190/1.1442837) which solves a fourth-order differential equation to produce the grid. Generic Mapping Tools (GMT) (Wessel, P., and W. H. F. Smith (1991), Free software helps map and display data, Eos 72(41), 140 441, 445-446), widely used in the scientific community, use this algorithm for gridding (GMT's “surface”). This method and others akin to it (e.g. Ch.3, Press et al. (2007), Numerical Recipes: the Art of Scientific Computing, 3 ed., Cambridge: Cambridge Univ. Press), however, often lack an inherent uncertainty estimator. A published estimation method is a Monte Carlo procedure (Jakobsson et al. (2002), On the effect of random errors in gridded bathymetric compilations, Journal of Geophysical Research-Solid Earth, 107(BI2), Article 2358, doi: 10.1029/20011B000616) that varies the positions and geophysical values of the original data and outputs a Splines-In-Tension grid for N iterations. The gridded uncertainty is the standard deviation of the N grids.

Another alternative is kriging, a mature interpolation methodology that provides a statistical uncertainty estimate that can be used as an uncertainty estimate. The interpolated surface can be a grid or more generalized. The disadvantages of kriging are as follows. First, kriging requires inverse matrix computations. While such computations are mature (Brandt, S. (1998), Data analysis: statistical and computational methods for scientists and engineers, 3rd ed., xxxiv, Appendix A, Springer, New York) and codified in a large number of software packages (MATLAB, Version 7.14 (2012), The Mathworks Inc. Natick, MA, http://www.mathworks.com) and numerical routines (Press et al. (2007), Numerical Recipes: the Art of Scientific Computing, 3rd ed., Cambridge: Cambridge Univ. Press, sections 2.3, 21.3, 21.6), matrix inversion is computationally intensive. Second, a required term in kriging's matrix equations is the semivariogram. Semivariograms can be difficult to model in a manner that matches empirical answers. As a result, when modeled semivariograms are used for kriging computations, they are approximations, introducing error that is difficult to quantify and propagate with the uncertainty estimate. Third, most commonly used kriging routines assume that a trend surface or mean surface for the data is zero (simple kriging), a non-zero constant (ordinary kriging), can be fitted with a polynomial surface (universal kriging), or some other non-linear model. The more generalized the trend surface, the more computationally intensive the procedure. What is needed is a method that is free from inverse matrix and semivariogram calculations.

Yet another alternative is to use the Monte Carlo procedure in (Jakobsson, M., B. et al. (2002), On the effect of random errors in gridded bathymetric compilations, Journal of Geophysical Research-Solid Earth, 107(BI2), Article 2358, doi: 10.1029/20011B000616). In this procedure, the gridding algorithm has to be potentially repeated a large number of times instead of having one block of code executed to obtain the estimate. There also is potentially a large amount of additional overhead with regard to file storage and access for computation of standard deviation after all (Davis, J. C. (2002), Statistics and Data Analysis in Geology, 3rd ed., Wiley, New York, pp. 419-443) simulations are complete. What is needed is a method that is free from Monte Carlo simulations.

Still another alternative is a technique by Calder, B. R. (2006), On the uncertainty of archive hydrographic data sets, IEEE Journal of Oceanic Engineering, 31 (2), 249-265. While this technique does provide uncertainty estimates, it does so with an even higher computational cost than the method in Jakobsson, M., B. et al. (2002), On the effect of random errors in gridded bathymetric compilations, Journal of Geophysical Research-Solid Earth, 107(BI2) due to the use of the localized regression technique given by Cleveland, W. S. (1979), Robust locally weighted regression and smoothing scatterplots. Journal of the American Statistical Association, 74(368), 829-836, and ordinary kriging. In addition, this technique assumes that the input data is at least one-order of magnitude denser spatially than the output grid. While this algorithm works well when this initial condition is met, the opposite initial condition—sparse input data and denser output grid—is often the working condition. What is needed is a method that supports sparse input data and honors input data if supported by the gridding algorithm.

### SUMMARY

The system and method of the present embodiment provide an uncertainty estimation algorithm for geophysical gridding routines that inherently lack the uncertainty estimate. The method for uncertainty estimation is free from Monte Carlo simulations and uses an augmented zeroth-order uncertainty estimate from the Combined Uncertainty and Bathymetry Estimator (CUBE) (Calder, B. R., and L. A. Mayer (2003), Automatic processing of high-rate, high-density multibeam echo sounder data, Geochemistry Geophysics Geosystems, 4, Art. No. 1 048, doi: 10.102912002GC000486). The augmented estimator accounts for additional uncertainty due to bottom slope and is used with slope and triangularization such as, for example, but not limited to, Delaunay triangularization, for nearest neighbor search to obtain gridded uncertainty in process flow. Inputs to the augmented estimator are positions, geophysical values, horizontal and geophysical uncertainty of the input data points, and gridded slope of the gradient as calculated from an interpolated grid. The augmented estimator method of the present embodiment can be applied to various kinds of data including, but not limited to, bathymetry data and some kinds of geophysical data. The augmented estimator system and method are independent of the interpolator used for creating the interpolated grid, and can calculate the uncertainty estimate in one process block instead of using Monte Carlo simulations. Computation of semivariograms, and matrix inversion required by alternative kriging methods, are not required.

The method of the present embodiment for providing an uncertainty estimation algorithm for geophysical gridding routines that inherently lack the uncertainty estimate can include, but is not limited to including, propagating navigation uncertainty to bathymetry uncertainty, applying the augmented estimator of the present embodiment to single grid points, and creating an uncertainty grid from the single grid points. The standard zeroth-order CUBE estimator is based on horizontal and vertical uncertainty of the grid points, distance between grid points, propagated uncertainty from one grid point to another, and output grid spacing. As shown in Jakobsson et al. (2002), On the effect of random errors in gridded bathymetric compilations. Journal of Geophysical Research-Solid Earth, 107(BI2) Article 2358, doi: 10.1029/20011B000616, bottom slope affects total uncertainty. Thus, to propagate navigation uncertainty to bathymetry uncertainty for grid points on slopes, the CUBE estimator can be augmented to be based on the output from a gridding algorithm using standard slope calculation routines, navigation uncertainty, and the seafloor slope along the path of steepest descent relative to a flat ocean surface.

The method of the present embodiment for improving the accuracy of a numerical model by estimating uncertainty for gridding algorithms can include, but is not limited to including, creating a bathymetry grid having grid points based on observed bathymetry soundings of a water body. The created bathymetry grid can have a pre-selected grid point spacing and can be based on observed bathymetry depths, observed depth locations, estimated horizontal uncertainty of the depths, and estimated vertical uncertainty of the depths. The method can also include calculating a gridded slope of the bottom of the water body based on the bathymetry grid, and estimating uncertainty of the observed bathymetry based on the bathymetry grid and the gridded slope. Estimating can be accomplished by (a) creating a triangular irregular network (TIN) for every grid point in the bathymetry grid based on the observed depth locations used to compute the bathymetry grid, (b) determining an encompassing triangle, that is, a triangle connecting observed depth locations that surround each of the grid points in the bathymetry grid, (c) calculating a distance from each of the grid points to each vertex of the encompassing triangle, (d) computing a distance dependent uncertainty for each vertex of the encompassing triangle based on the estimated vertical uncertainty, the distances, the estimated horizontal uncertainty, the gridded slope, and the pre-selected grid point spacing, and (e) computing a point uncertainty estimate for each of the grid points based on inverse distance weighting of the squared distance dependent uncertainties.

The method can optionally include providing the uncertainty to the numerical model. The TIN can optionally be created by Delaunay triangularization. Computing the distance dependent uncertainty can include, but is not limited to including, calculating

$${σ}_{ij}^{2} = {σ}_{V , i}^{2} ( 1 + {[ \frac{{d}_{ij} + {S}_{H} {σ}_{H , i}}{{Δ}_{grid}} ]}^{α} ) + {σ}_{H , i}^{2} {tan}^{2} {θ}_{j}$$

where σᵢⱼ² is the distance dependent uncertainty at j due to the i^{th} estimated vertical uncertainties σ_{V,i}² and the i^{th} estimated horizontal uncertainties σ_{H,i}², d_{i,j} is the radial distance between i and j, Δ_{grid} is the pre-selected grid point spacing, S_{H} is a magnification coefficient for a worst expected σ_{H,i} , α is a pre-selected exponent that represents growth of the uncertainty over distance, and θⱼ is a slope angle determined from the gridded slope. The method can still further optionally include setting the magnification coefficient to between 1 and 2, setting the pre-selected constant to less than 10, or setting a minimum for the pre-selected grid point spacing.

An alternative method for improving the accuracy of a numerical model by estimating uncertainty of a pre-selected parameter for gridding algorithms can include, but is not limited to including, creating a grid, the created grid having grid points and a pre-selected grid point spacing, the created grid being based on observations of the pre-selected parameter. The created grid can be based on observations of the pre-selected parameter, and the observations can include observation locations, estimated horizontal uncertainty of the parameter, and estimated vertical uncertainty of the parameter. The alternative method can include calculating a gridded slope of the observations based on the grid, and estimating uncertainty of the observations based on the grid and the gridded slope. Estimating can be accomplished by (a) creating a triangular irregular network (TIN) for every grid point in the grid based on the observation locations used to compute the grid, (b) determining an encompassing triangle, that is, a triangle connecting observation locations that surround each of the grid points in the grid, (c) calculating a distance from each of the grid points to each vertex of the encompassing triangle, (d) computing a distance dependent uncertainty for each vertex of the encompassing triangle based on the estimated vertical uncertainty, the distances, the estimated horizontal uncertainty, the gridded slope, and the pre-selected grid point spacing, and (e) computing a point uncertainty estimate based on inverse distance weighting of the squared uncertainties.

The alternative method can optionally include providing the point uncertainty estimates to the numerical model. The TIN can be created by Delaunay triangularization. Computing the distance dependent uncertainty can include, but is not limited to including, calculating

$${σ}_{ij}^{2} = {σ}_{V , i}^{2} ( 1 + {[ \frac{{d}_{ij} + {S}_{H} {σ}_{H , i}}{{Δ}_{grid}} ]}^{α} ) + {σ}_{H , i}^{2} {tan}^{2} {θ}_{j}$$

where σᵢⱼ² is the distance dependent uncertainty at j due to the i^{th} estimated vertical uncertainties σ_{V,i}² and the i^{th} estimated horizontal uncertainties σ_{H,i}², dᵢⱼ is the radial distance between i and j, Δ_{grid} is the pre-selected grid point spacing, S_{H} is a magnification coefficient for a worst expected σ_{H,i}, α is a pre-selected exponent that represents growth of the uncertainty over distance, and θⱼ is a slope angle determined from the gridded slope. The alternative method can optionally include setting the magnification coefficient to between 1 and 2, setting the pre-selected constant to less than 10, and setting a minimum for the pre-selected grid point spacing.

The system of the present embodiment for improving the accuracy of a numerical model by estimating uncertainty for gridding algorithms can include, but is not limited to including a bathymetry grid processor creating a bathymetry grid based on observed bathymetry soundings of bathymetry depths of a water body. The bathymetry grid can have grid points and a pre-selected grid point spacing and can be based on observed bathymetry depths, observed depth locations, estimated horizontal uncertainty of the depths, and estimated vertical uncertainty of the depths. The system can further include a gridded slope processor calculating a gridded slope of the bottom of the water body based on the bathymetry grid and an uncertainty processor computing an estimated uncertainty of observed bathymetry based on the bathymetry grid and the gridded slope. The uncertainty processor can include a TIN and triangle processor creating a triangular irregular network (TIN) for every grid point in the bathymetry grid based on the observed depth locations and an observed uncertainty processor determining an encompassing triangle. The encompassing triangle can connect the observed depth locations surrounding each grid point in the bathymetry grid. The observed uncertainty processor can also calculate a distance from each of the grid points to each vertex of the encompassing triangle. The uncertainty processor can also include a grid point uncertainty processor computing a distance dependent uncertainty for each vertex of the encompassing triangle based on the estimated vertical uncertainty, the distances, the estimated horizontal uncertainty, the gridded slope, and the pre-selected grid point spacing. The grid point uncertainty processor can compute the estimated uncertainty based on inverse distance weighting of the distance dependent uncertainties, and can optionally provide the estimated uncertainty to the numerical model. The system can optionally include an input processor receiving the observed bathymetry depths, the observed depth locations, the estimated horizontal uncertainty, and the estimated vertical uncertainty from an electronic communications device.

### BRIEF DESCRIPTION OF THE DRAWINGS

FIG. 1 (PRIOR ART) is a schematic block diagram of the Monte Carlo procedure;

FIG. 2 is a schematic block diagram of the uncertainty estimation method of the present embodiment;

FIG. 3 is a pictorial representation of the derivation of the added uncertainty term of the present embodiment;

FIG. 4 is a graphical representation illustrating the use of a triangular irregular network to find three nearest input point neighbors to each output point, calculation of corresponding Euclidian distances, and use of uncertainties for input points in equation (2);

FIG. 5 is a pictorial and schematic block diagram of the inputs and outputs of the system of an alternate embodiment;

FIGS. 6A-6F are graphical representations of uncertainties computed under various circumstances;

FIG. 7 is a flowchart of the method of the present embodiment; and

FIG. 8 is a schematic block diagram of the system of the present embodiment.

### DETAILED DESCRIPTION

The problems set forth above, as well as, further and other problems are solved by the present teachings. These solutions and other advantages are achieved by the various embodiments of the teachings described herein below.

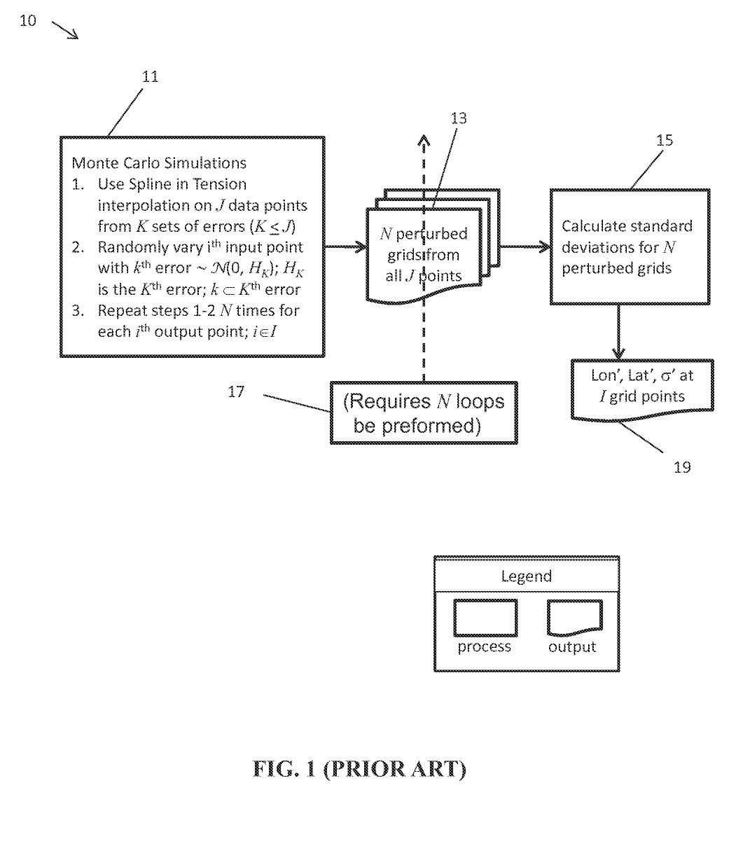

Referring now to FIG. 1 (PRIOR ART), shown is a conceptual organization of Monte Carlo method 10 applied to error estimation. Errors are estimated via sample statistics computed pointwise over pseudo-randomly generated grids. In particular Monte Carlo simulation 11 can include interpolating and randomly varying input points with errors, and repeating 17 the interpolating/varying steps up to twice the number of perturbed grids 13 produced, which are used to calculate 15 standard deviations and their locations 19 for each of the perturbed grids. Not only is this a computationally expensive process due to the interpolations and standard deviation calculations, but there is also a heavy input/output load on the system because much data are required to interpolate and compute standard deviations.

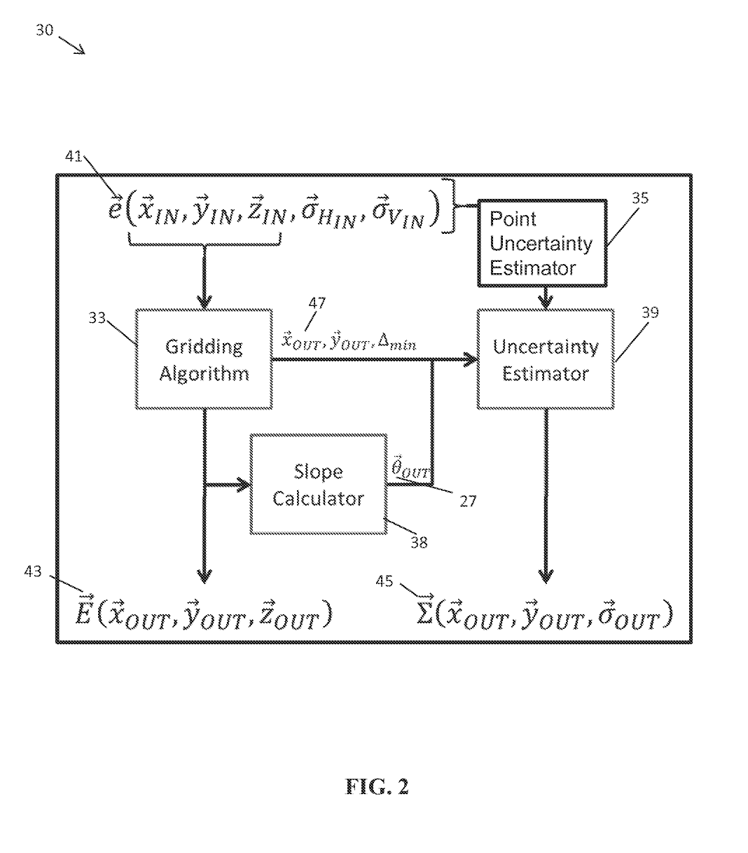

Referring now to FIG. 2, uncertainty estimation method 30 is shown. If i=1,. . . , I Input points and j=1 . . . J output points, the zeroth-order CUBE uncertainty estimator is (Eq. (A1) in Calder, B. R., and L. A. Mayer (2003), Automatic processing of high-rate, high-density multibeam echo sounder data, Geochemistry Geophysics Geosystems, 4, Art. No. 1 048, doi: 10.102912002GC000486:

$${σ}_{ij}^{2} = {σ}_{V , i}^{2} ( 1 + {[ \frac{{d}_{ij} + {S}_{H} {σ}_{H , i}}{{Δ}_{grid}} ]}^{α} ) \qquad ( 1 )$$

where σᵢⱼ² the squared distance dependent uncertainty from i to j due to the i^{th} vertical and horizontal uncertainties, σ_{V,i}² and σ_{H,i}², dᵢⱼ is the radial distance between i and j, and Δ_{grid} is the output grid spacing (or minimum spacing for non-square grids). Stated a different way, each i^{th} point has a total propagated positional uncertainty, σ_{H,i}, and a total propagated vertical uncertainty, σ_{V,i}, attributed to it. These uncertainties are used to compute a total propagated uncertainty, σⱼ², at each j^{th} gridded depth. Parameters S_{H}, magnification coefficient for worst expected σ_{H,i}, and α can be provided or automatically determined. Exemplary values are S_{H}=1.96 and α=2 (Calder, B. R., and L. A. Mayer (2003), Automatic processing of high-rate, high-density multibeam echo sounder data, Geochemistry Geophysics Geosystems, 4, Art. No. 1 048, doi: 10.102912002GC000486).

To locate the nearest-neighboring i to j, the method of the present embodiment automatically computes a triangular irregular network (TIN), for example, but not limited to, a Delauney TIN, of the input positions 41 and stores the TIN to, for example, but not limited to, memory. For a specific j contained inside the convex hull, the TIN is searched for a circumscribing triangle. The Euclidean distances in meters from j to the circumscribing vertices are the values for dᵢⱼ 25 (FIG. 4) for i=1, 2, and 3. Method 30 assumes that all J points 23 (FIG. 4) are contained inside the convex hull of the TIN. Circumscribing neighbors guarantee that information (for example, but not limited to, uncertainty) to the point of interest, j, is from spatially equitable control points.

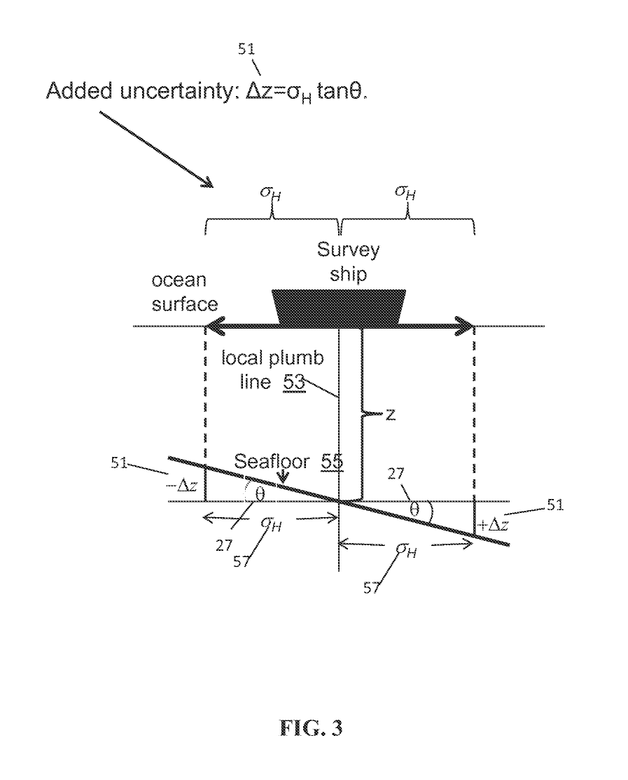

As shown in Jakobsson et al. (2002), On the effect of random errors in gridded bathymetric compilations, Journal of Geophysical Research-Solid Earth 107(BI2), Article 2358, doi: 10.1029/20011B000616, positional uncertainty of the navigation propagates into depth uncertainty when the bottom has slope relative to a flat ocean surface. Trigonometrically, along the path of steepest descent with slope at angle θ=arctan(|∇|), this added uncertainty is Δz=σ_{H} tan θ 51 (FIG. 3), the resultant bathymetry uncertainty from navigation uncertainty. In the present embodiment, therefore, equation (1) is augmented to account for slope at j, θⱼ, by adding σ_{H,i}² tan²θⱼ as an extra uncertainty term so that

$${σ}_{ij}^{2} = {σ}_{V , i}^{2} ( 1 + {[ \frac{{d}_{ij} + {S}_{H} {σ}_{H , i}}{{Δ}_{grid}} ]}^{α} ) + {σ}_{H , i}^{2} {tan}^{2} {θ}_{j} \qquad ( 2 )$$

where θⱼ is computed by slope calculator 38 based on bathymetry grid 43 computed by gridding algorithm 33. In more general terms, positional uncertainty propagates into uncertainty of the field quantity that can be estimated by Δz=σ_{H,i}|∇z|, which is then used with the σ_{V,i} terms on the right hand side in equation (1). Slope calculator 38 can compute slope angle θ 27, the seafloor slope along the path of steepest descent, relative to a flat ocean surface. Uncertainty estimator 39 can compute the final uncertainty 45 from inverse-distance-weighted average of uncertainties computed from equation (2), using and the inputs from point uncertainty estimator 35 including the attributes from the vertices 37 (FIG. 4) of the circumscribing triangle.

Referring now to FIG. 3, added uncertainty 51 trigonometric derivation is shown pictorially. In particular, Δz 51 varies horizontally from local plumb line 53 with the depth of seafloor 55. Horizontal standard deviation σ_{H} 57 can be determined if Δz 51 and θ 27 are known.

Referring now to FIG. 4, the steps of loading input positions, depths, horizontal and vertical uncertainties, outputting gridded bathymetry, calculating gridded slope from the output grid, estimating uncertainty based on the gridded bathymetry and slope, creating TIN of input positions and for every j^{th} grid point, and outputting a gridded uncertainty surface can be used to locate three circumscribing neighbors 37 to output point j 23 for calculation of dᵢⱼ 25 in equation (2). Equation (2) is then used to calculate σ_{1,j}², σ₂ⱼ², σ₃ⱼ². With these quantities, a final inverse distance weighted uncertainty estimate,

$${σ}_{ij}^{2} = \frac{{\sum }_{i = 1}^{3} {d}_{ij}^{- 1} {σ}_{ij}^{2}}{{\sum }_{i = 1}^{3} {d}_{ij}^{- 1}} \qquad ( 3 )$$

is computed for j. The uncertainty estimate at j is its square root, σⱼ. Equation (3) is free from the need to solve linear algebra equations, is computationally efficient, and is accurate enough for estimation of σⱼ.

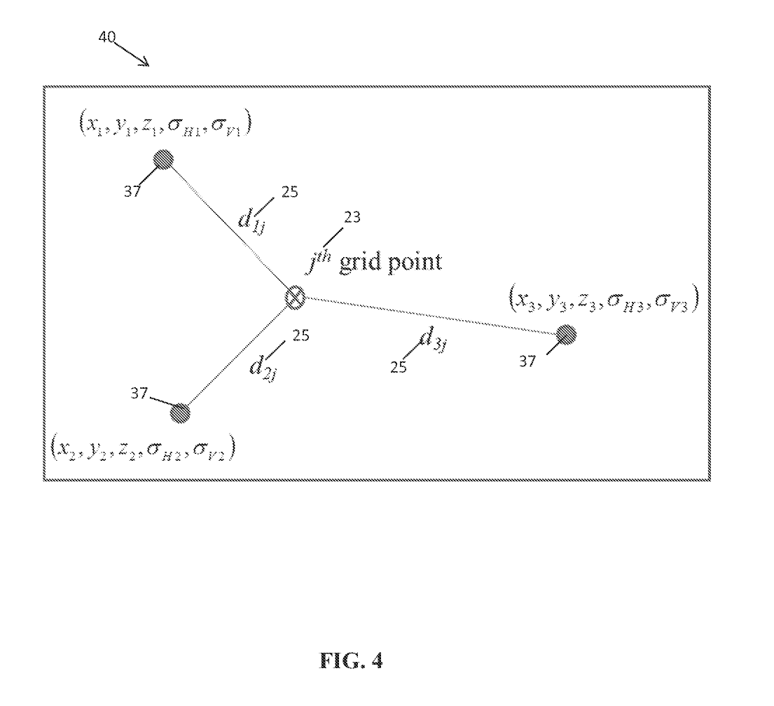

Referring now to FIG. 5, method 20, an alternative embodiment, is depicted schematically. In particular, method 20 includes, but is not limited to including, loading observed positions, depths, and horizontal and vertical uncertainties 41 (for observations), outputting gridded bathymetry \vec{E} 43, calculating gridded slope 109 based on output grid 43, and estimating uncertainty based on gridded bathymetry spacing 29 and slope 109. To estimate the uncertainty, method 20 can create a TIN of input positions including finding an encompassing triangle of soundings 37 for every j^{th} grid point 23, compute dᵢⱼ 25 from each i=1 . . . 3 vertex neighbor (circumscribing) (observed soundings 37 found with triangularization), compute σᵢⱼ² for i=1,2,3, perform inverse distance weighting of the three σᵢⱼ² for i=1,2,3, compute slope 109 at j from third-order differences of gridded bathymetry, compute σᵢⱼ from upgraded estimator equation (2), and compute a final σⱼ=inverse distance weighted average of three σᵢⱼ. Gridding algorithm 33 can compute output grid \vec{E} 43 and gridding algorithm output 47, slope calculator 38 can compute gridded slope θ 109, and point uncertainty estimator 35 can compute final σⱼ to provide to uncertainty estimator 39 (FIG. 2) to create gridded uncertainty surface \vec{Σ} 45.

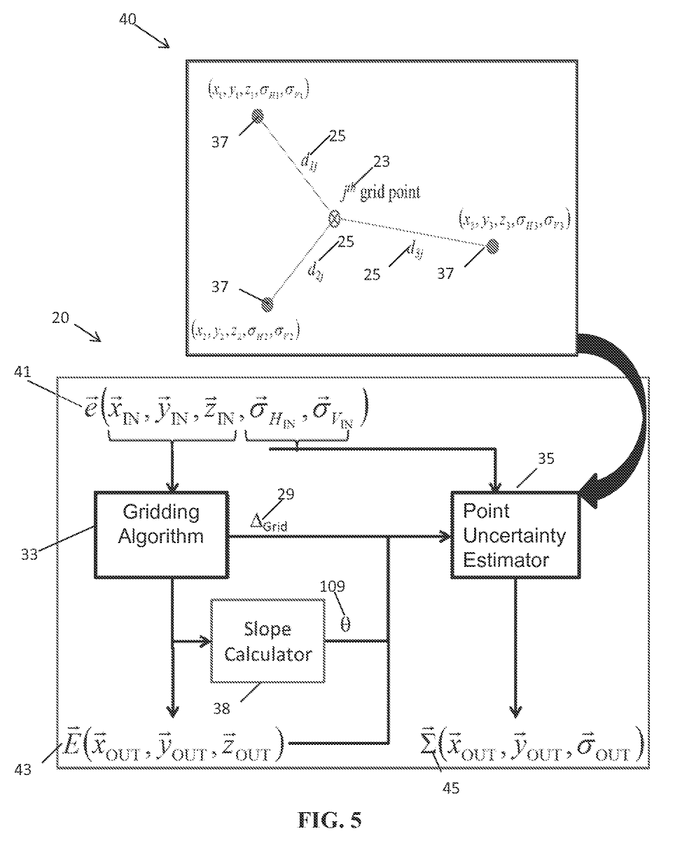

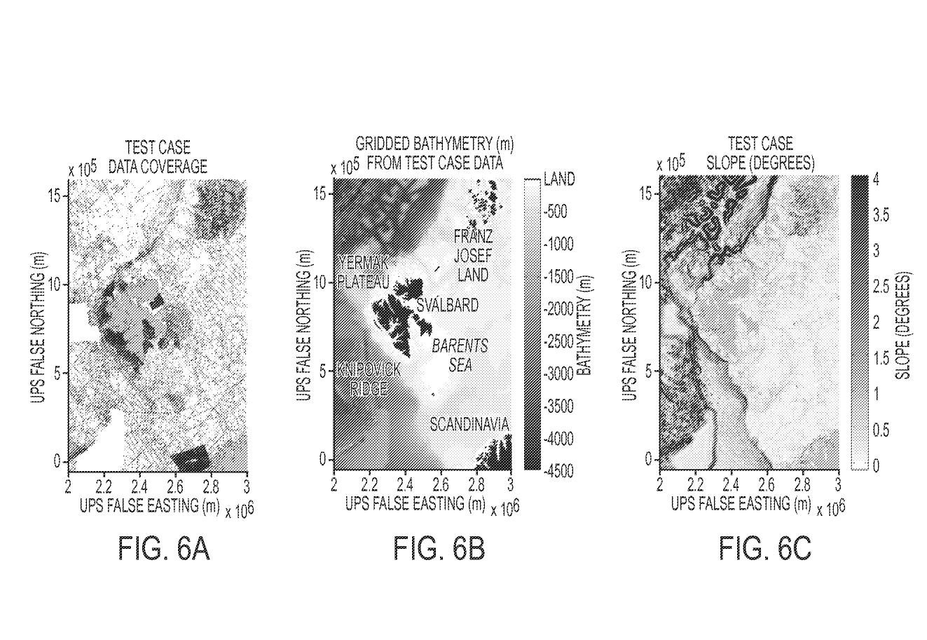

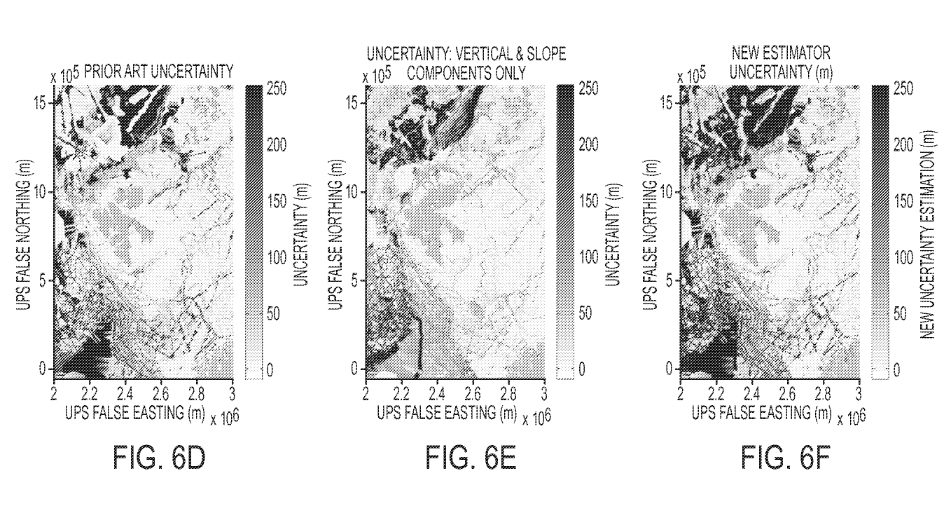

Referring now to FIGS. 6A-6F, gridded bathymetry from test cases is shown for the region around Svalbard. FIG. 6A shows coverage and where artificial gaps exist to the east and south of Svalbard. These data were gridded to a 2.5 km grid using Splines-In-Tension from GMT surface (FIG. 6B). Slope (FIG. 6C) is calculated by third-order finite-differences (Horn, K. P., Hill shading and the Reflectance Map, Proceedings of the IEEE, Vol. 69, No. 1, 1981; Zhou, Q. and Liu X., Error Analysis on Grid-Based Slope and Aspect Algorithms, Photogrammetric Engineering & Remote Sensing, Vol. 70, No. 8, August 2004, pp. 957-962). The TIN can be calculated from, for example, but not limited to, the “DelaunayTri” class in packages MATLAB, Version 7.14 (2012), The Mathworks Inc. Natick, Mass., http://www.mathworks.com, which has a “nearestNeighbor” method to return the nearest-neighbor and Euclidean distance. Setting S_{H}=1 (worst assumed horizontal uncertainty=standard deviation) and maintaining α=2 in equation (1) and equation (2), gridded uncertainty can be estimated three ways: from equation (1) alone (FIG. 2D), use of σ_{V,i}²+σ_{H,i}² tan²θⱼ only (FIG. 2E), and then from equation (2) (FIG. 2F), to illustrate the effects of the second and third terms in equation (2). Use of equation (1) shows high uncertainty where there are gaps in data coverage. The components of uncertainty from just σ_{V,i}²+σ_{H,i}² tan²θⱼ show greater uncertainty where sloped seafloor is present. These first two cases also show larger uncertainty (visible tracks and lines) for specific input sets with high uncertainties relative to other sets. Use of equation (2) shows uncertainty from all of these effects. The use σ_{H,i}² tan²θⱼ n the third term of equation (2) maximizes the uncertainty from slope by using the value along the path of steepest descent and simplifies computations. The line segment between i and j is generally at an azimuthal angle, ψ_{i,j}. In an alternative embodiment, the third term could be σ_{H,i}² tan²θⱼ cos²ψ_{i,j}. Angle ψ_{i,j}, however, can vary by ±Δψ_{i,j} due to σ_{H,i} for the i^{th} position. The maximum Δψ_{i,j} occurs when this position varies perpendicular to line segment dᵢⱼ by ±σ_{H,i} so that Δψ_{i,j}=arctan(σ_{H,i}/dᵢⱼ). Thus, the modified third term would become σ_{H,i}²tan²θⱼ multiplied by the maximum value of cos²ψ_{i,j} as ψ_{i,j} varies from ψ_{i,j}−Δψ_{i,j} to ψ_{i,j}+Δψ_{i,j}. The system and method of the present embodiment are independent of the interpolator used for gridding, the nearest-neighbor methods used, and the scripting and programming languages used.

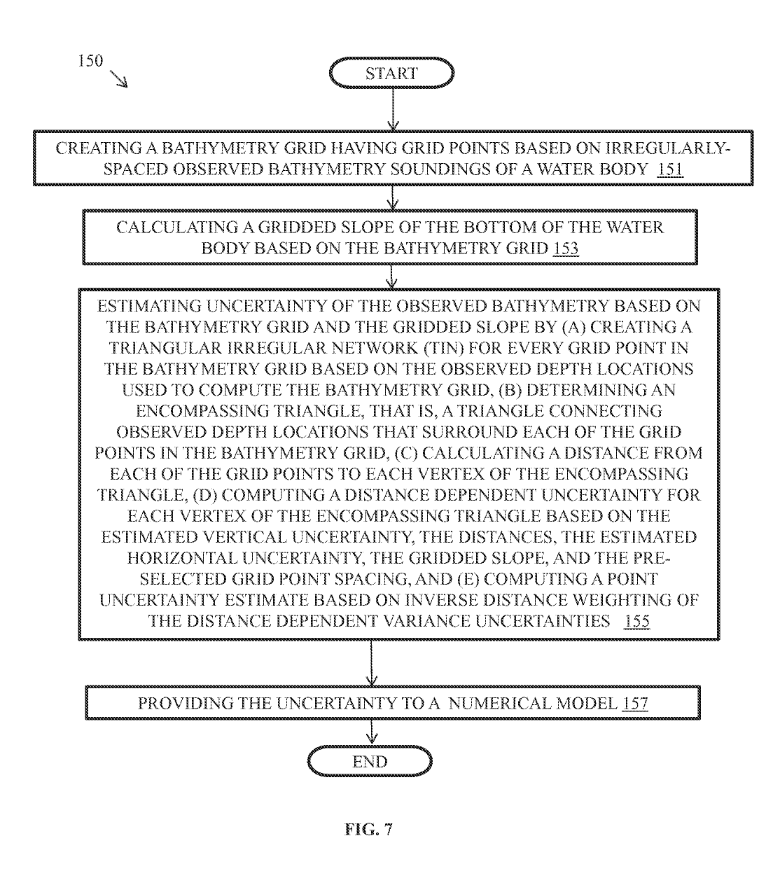

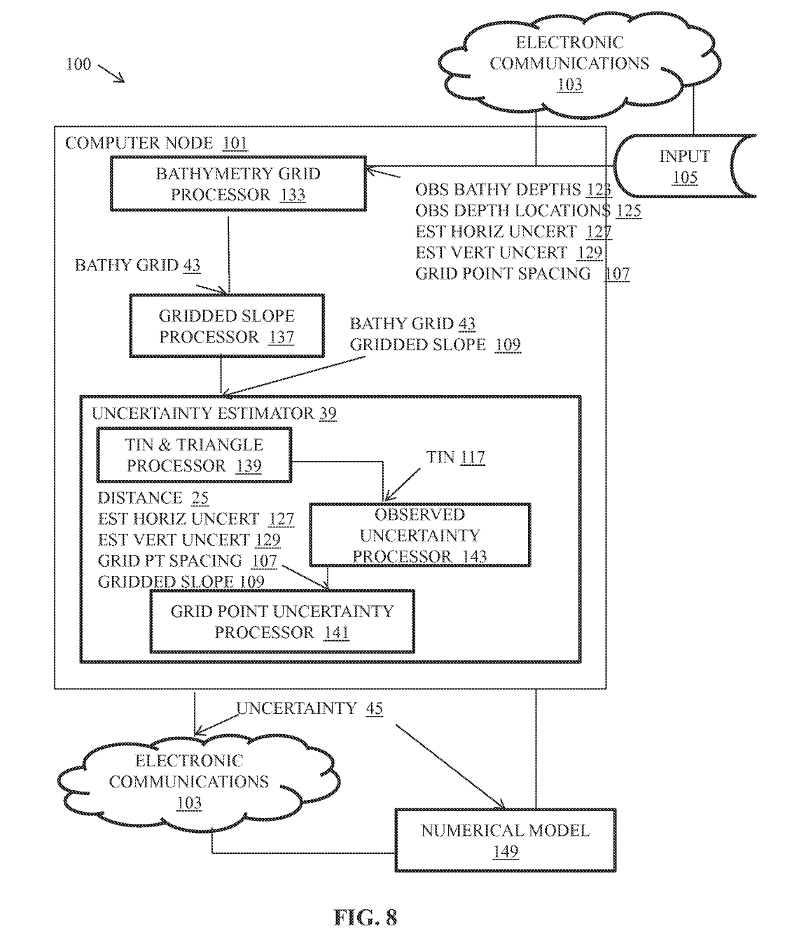

Referring now to FIG. 7, method 150 of the present embodiment for improving the accuracy of a numerical model by estimating uncertainty for gridding algorithms can include, but is not limited to including, (1) creating 151 a bathymetry grid having grid points based on irregularly-spaced observed bathymetry soundings of a water body. The bathymetry grid is a calculated approximation of the ocean bottom that includes geospatial location and depth. The created bathymetry grid has a pre-selected grid point spacing, and is based on observed bathymetry depths, observed depth locations, estimated horizontal uncertainty of the observed depths, and estimated vertical uncertainty of the observed depths. Method 150 can also include (2) calculating 153 a gridded slope of the bottom of the water body based on the bathymetry grid, and (3) estimating 155 uncertainty of the observed bathymetry based on the bathymetry grid and the gridded slope by (a) creating a triangular irregular network (TIN) for every grid point in the bathymetry grid based on the observed depth locations used to compute the bathymetry grid, (b) determining an encompassing triangle, that is, a triangle connecting observed depth locations that surround each of the grid points in the bathymetry grid, (c) calculating a distance from each of the grid points to each vertex of the encompassing triangle, (d) computing a distance dependent uncertainty for each vertex of the encompassing triangle based on the estimated vertical uncertainty, the distances, the estimated horizontal uncertainty, the gridded slope, and the pre-selected grid point spacing, and (e) computing a point uncertainty estimate based on inverse distance weighting of the squared uncertainties. Method 150 can optionally include providing 157 the uncertainty to the numerical model.

Method 150 uses a TIN because the result is a network of triangles in which the interior angles of each triangle are maximized throughout the mesh, The TIN technique selects three gridded bathymetry spacing points that are as far apart azimuthally from each other as possible. One such conventional technique is Delaunay triangularization which can be computed by functions such as, for example, but not limited to, “delaunay” supplied by the MATLAB® corporation.

In another embodiment, an alternative method for improving the accuracy of a numerical model by estimating uncertainty of a pre-selected parameter for gridding algorithms can include, but is not limited to including, (1) creating a grid having grid points based on irregularly-spaced observations of the pre-selected parameter. The grid is a calculated approximation of the observations. The grid has a pre-selected grid point spacing, and is based on observations, observation locations, estimated horizontal uncertainty of the observations, and estimated vertical uncertainty of the observations. The alternative method can also include (2) calculating a gridded slope of the observations based on the grid, and (3) estimating uncertainty of the observations based on the grid and the gridded slope by (a) creating a triangular irregular network (TIN) for every grid point in the grid based on the observation locations used to compute the grid, (b) determining an encompassing triangle, that is, a triangle connecting observation locations that surround each of the grid points in the grid, (c) calculating a distance from each of the grid points to each vertex of the encompassing triangle, (d) computing a distance dependent uncertainty for each vertex of the encompassing triangle based on the estimated vertical uncertainty, the distances, the estimated horizontal uncertainty, the gridded slope, and the pre-selected grid point spacing, and (e) computing a point uncertainty estimate based on inverse distance weighting of the squared uncertainties. The alternative method can optionally include providing the uncertainty to the numerical model.

Referring now to FIG. 8, system 100 for improving the accuracy of a numerical model by estimating uncertainty for gridding algorithms can include, but is not limited to including, bathymetry grid processor 133 executing on computer node 101, bathymetry grid processor 133 creating bathymetry grid 43 having grid points based on irregularly-spaced observed bathymetry soundings of bathymetry depths 123 of a water body, bathymetry grid 43 having pre-selected grid point spacing 107, bathymetry grid 43 being based on observed bathymetry depths 123, observed depth locations 125, estimated horizontal uncertainty 127 of the depths, and estimated vertical uncertainty 129 of the depths. System 100 can receive observed bathymetry depths 123, observed depth locations 125, estimated horizontal uncertainty 127, and estimated vertical uncertainty 129 from, for example, but not limited to, electronic communications 103 and/or user input 105. System 100 can also include gridded slope processor 137 calculating gridded slope 109 of the bottom of the water body based on bathymetry grid 43. System 100 can still further include uncertainty estimator 39 estimating uncertainty 147 of observed bathymetry 123 based on bathymetry grid 43 and gridded slope 109. Uncertainty estimator 39 can include, but is not limited to including, TIN and triangle processor 139 creating triangular irregular network (TIN) 117 for every grid point in bathymetry grid 43 based on observed depth locations 125 used to compute bathymetry grid 43. Uncertainty estimator 39 can further include observed uncertainty processor 143 determining an encompassing triangle, that is, a triangle connecting observed depth locations 125 that surround each of the grid points in bathymetry grid 43, and calculating distance 25 from each of the grid points to each vertex of the encompassing triangle. Uncertainty processor 39 can even still further include grid point uncertainty processor 141 computing a distance dependent uncertainty for each vertex of the encompassing triangle based on estimated vertical uncertainty 129, distances 25, estimated horizontal uncertainty 127, gridded slope 109, and pre-selected grid point spacing 107, and computing estimated uncertainty 45 based on inverse distance weighting of the squared uncertainties. Uncertainty estimator 39 can optionally provide the estimated uncertainty 45 to numerical model 149 directly or, for example, via electronic communications 103.

Embodiments of the present teachings are directed to computer systems for accomplishing the methods discussed in the description herein, computer systems that can include software, firmware, and/or hardware components to accomplish the uncertainty estimate. Computer code can be embodied on computer readable media. The raw data and results can be stored for future retrieval and processing, printed, displayed, transferred to another computer, and/or transferred elsewhere. Communications links can be wired or wireless, for example, using cellular communication systems, military communications systems, and satellite communications systems. Computer code can be written in any computer language. The system, including any software, hardware, and firmware, can be invoked by a computer having a variable number of CPUs. Other alternative computer platforms can be used. The operating system can be, for example, but is not limited to, the WINDOWS® operating system or the LINUX® operating system.

The present embodiment is also directed to computer code for accomplishing the methods discussed herein, and computer readable media, firmware, and/or hardware storing and executing computer code for accomplishing these methods. The various modules described herein can be accomplished on the same CPU, on multiple CPUs in parallel, or can be accomplished on different computers. In compliance with the statute, the present embodiment has been described in language more or less specific as to structural and methodical features. It is to be understood, however, that the present embodiment is not limited to the specific features shown and described, since the means herein disclosed comprise preferred forms of putting the present embodiment into effect.

Referring again primarily to FIG. 7, method 150 can be, in whole or in part, implemented electronically. Signals representing actions taken by elements of system 100 (FIG. 8) and other disclosed embodiments can travel over at least one live communications network 103 (FIG. 8). Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read.

Although the present teachings have been described with respect to various embodiments, it should be realized these teachings are also capable of a wide variety of further and other embodiments.

What is claimed is:

1. A method for improving the accuracy of a numerical model by estimating uncertainty for gridding algorithms comprising:
creating a bathymetry grid of a water body, the created bathymetry grid having grid points and a pre-selected grid point spacing, the created bathymetry grid being based on observed bathymetry, the observed bathymetry including observed bathymetry depths, observed depth locations, estimated horizontal uncertainty of the observed bathymetry depths, and estimated vertical uncertainty of the observed bathymetry depths;
calculating a gridded slope of the bottom of the water body based on the bathymetry grid; and
estimating uncertainty of the observed bathymetry based on the bathymetry grid and the gridded slope by (a) creating a triangular irregular network (TIN) for every grid point in the bathymetry grid, the TIN being based on the observed depth locations used to compute the bathymetry grid, (b) determining an encompassing triangle connecting the observed depth locations surrounding each of the grid points in the bathymetry grid, (c) calculating a distance from each of the grid points to each vertex of the encompassing triangle, (d) computing a distance dependent uncertainty for each vertex of the encompassing triangle based on the estimated vertical uncertainty, the distances, the estimated horizontal uncertainty, the gridded slope, and the pre-selected grid point spacing, and (e) computing a point uncertainty estimate for each of the grid points based on inverse distance weighting of the squared distance dependent uncertainties.

2. The method as in claim 1 further comprising:
providing the point uncertainty estimates to the numerical model.

3. The method as in claim 1 wherein the TIN is created by Delaunay triagularization.

4. The method as in claim 1 wherein computing the distance dependent uncertainty comprises:
calculating
$${σ}_{ij}^{2} = {σ}_{V , i}^{2} ( 1 + {[ \frac{{d}_{ij} + {S}_{H} {σ}_{H , i}}{{Δ}_{grid}} ]}^{α} ) + {σ}_{H , i}^{2} {tan}^{2} {θ}_{j}$$
where σᵢⱼ² is the distance dependent uncertainty at j due to the i^{th} estimated vertical uncertainties σ_{V,i}² and the i^{th} estimated horizontal uncertainties σ_{H,i}²;
dᵢⱼ is the radial distance between i and j;
Δ_{grid} is the pre-selected grid point spacing;
S_{H} is a magnification coefficient for a worst expected σ_{H,i};
α is a pre-selected exponent that represents growth of the uncertainty over distance; and
θⱼ is a slope angle determined from the gridded slope.

5. A system for improving the accuracy of a numerical model by estimating uncertainty for gridding algorithms comprising:
a bathymetry grid processor creating a bathymetry grid of a water body, the created bathymetry grid having grid points and a pre-selected grid point spacing, the bathymetry grid being based on observed bathymetry, the observed bathymetry including bathymetry depths, observed depth locations, estimated horizontal uncertainty of the observed bathymetry depths, and estimated vertical uncertainty of the observed bathymetry depths;
a gridded slope processor calculating a gridded slope of the bottom of the water body based on the bathymetry grid; and
an uncertainty processor computing an estimated uncertainty of observed bathymetry based on the bathymetry grid and the gridded slope, the uncertainty processor including:
a TIN and triangle processor creating a triangular irregular network (TIN) for every grid point in the bathymetry grid, the TIN being based on the observed depth locations used to compute the bathymetry grid;
an observed uncertainty processor determining an encompassing triangle connecting the observed depth locations surrounding each of the grid points in the bathymetry grid, the observed uncertainty processor calculating a distance from each of the grid points to each vertex of the encompassing triangle; and
a grid point uncertainty processor computing a distance dependent uncertainty for each vertex of the encompassing triangle based on the estimated vertical uncertainty, the distances, the estimated horizontal uncertainty, the gridded slope, and the pre-selected grid point spacing, the grid point uncertainty processor computing the estimated uncertainty based on inverse distance weighting of the distance dependent uncertainties.

6. The system as in claim 5 wherein the grid point uncertainty processor provides the estimated uncertainty to a numerical model.

7. The system as in claim 5 further comprising:
an input processor receiving the observed bathymetry depths, the observed depth locations, the estimated horizontal uncertainty, and the estimated vertical uncertainty from an electronic communications device.
